(19) United States
(12) Patent Application Publication
(10) Pub. No.: US 2017/0202184 A1
(43) Pub. Date: Jul. 20, 2017

(54) LEASH WITH VARIABLE ANCHOR

(71) Applicant: Jacqueline Moore, Los Angeles, CA (US)

(72) Inventor: Jacqueline Moore, Los Angeles, CA (US)

(21) Appl. No.: 15/406,551

(22) Filed: Jan. 13, 2017

Related U.S. Application Data
(60) Provisional application No. 62/278,890, filed on Jan. 14, 2016.

(51) Int. Cl. A01K 27/00; A44B 13/00; A44B 11/26; A44B 13/02; A44B 11/00

(52) U.S. Cl. CPC A01K 27/003; A44B 13/02; A44B 11/00; A44B 11/26; A44B 13/0058; A01K 27/005

(57) ABSTRACT

A leash-with-variable-anchor has two opposing fastener structures, one for removable attachment to a collar or to a harness; and another for fastening back onto a portion of an elongate-member of the leash, forming a looped structure, an anchor. The anchor may function as a handle. The anchor may also be quickly, easily, and safely attached to various articles, such as, but not limited to, posts; and without a need of detaching from the collar or from the harness. In some embodiments, the loop structure of the anchor may be variable (i.e., adjustable) in size.

### PRIORITY NOTICE

The present application claims priority under 35 U.S.C. §119(e) to U.S. Provisional Patent Application Ser. No. 62/278,890 filed on Jan. 14, 2016, the disclosure of which is incorporated herein by reference in its entirety.

### TECHNICAL FIELD OF THE INVENTION

The present invention relates in general to leashes and more specifically to leashes for pets, such as dogs, and wherein such leashes have a variable anchor that may serve as the handle.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Currently (circa 2016), leashes, as in dog leashes, typically have a clip end for attachment to a collar and an opposing integral handle. It is often desirable to attach such leashes to an article, such as a post. One may have a need to be hands-free from the least, for example, to sit down and drink a beverage, eat, read, converse, and the like. To attach such leashes to the article one either has to physically tie the leash to the article; or one must pass a portion of the leash around the article, remove the pet from the clip end, pass the clip end through the handle, and then re-attach the clip end back to the pet. And to detach such a leash from the article the above steps must be repeated, in reverse. Thus, presently using such existing leashes to attach to the article is cumbersome and awkward, especially when one is already holding something in one hand; and may provide a safety issue, when the clip end is detached from the pet. It would be desirable to have a leash that may be removably anchored (i.e., attached) to such an article, in a manner that is quick, easy, and safe.

There then is a need in the art for a leash may be removably anchored (i.e., attached) to such an article, in a manner that is quick, easy, and safe.

It is to these ends that the present invention has been developed.

### BRIEF SUMMARY OF THE INVENTION

To minimize the limitations in the prior art, and to minimize other limitations that will be apparent upon reading and understanding the present specification, the present invention describes embodiments of a leash-with-variable-anchor that may comprise two opposing fastener structures, one for removable attachment to a collar or to a harness; and another for fastening back onto a portion of an elongate-member of the leash-with-variable-anchor, forming a looped structure, an anchor. The anchor may function as a handle. The anchor may also be quickly, easily, and safely attached to various articles, such as, but not limited to, posts; and without a need of detaching from the collar or from the harness. In some embodiments, the loop structure of the anchor may be variable (i.e., adjustable) in size.

It is an objective of the present invention to provide a leash that may be removably attached to an article, such as, but not limited to, a post, without having to detach the leash from a collar or from a harness.

It is another objective of the present invention to provide a leash that may be removably attached to an article without having to detach the leash from a collar or from a harness, in a manner that may be quick, easy, and safe.

It is yet another objective of the present invention to provide a leash with article attachment structure, an anchor, wherein a size of the anchor may be variable (i.e., adjustable).

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 may depict an embodiment of a leash-with-variable-anchor, as viewed from above with the leash-with-variable-anchor laid out in longitudinally extended configuration.

FIG. 2 may depict an embodiment of a leash-with-variable-anchor, as viewed from above with the leash-with-variable-anchor laid out in a substantially longitudinally extended configuration, but showing a looping structure in a process of forming an anchor.

### REFERENCE NUMERAL SCHEDULE

100 leash-with-variable-anchor 100
101 elongate-member 101
103 first-terminal-end 103
105 second-terminal-end 105
107 first-clip 107
109 second-clip 109
111 at least one hole 111
115 size-adjuster 115
200 leash-with-variable-anchor 200
201 elongate-member 201
203 first-terminal-end 203
205 second-terminal-end 205
207 first-fastener 207
209 second-fastener 209
211 second-fastener-receiver 211
217 anchor 217

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

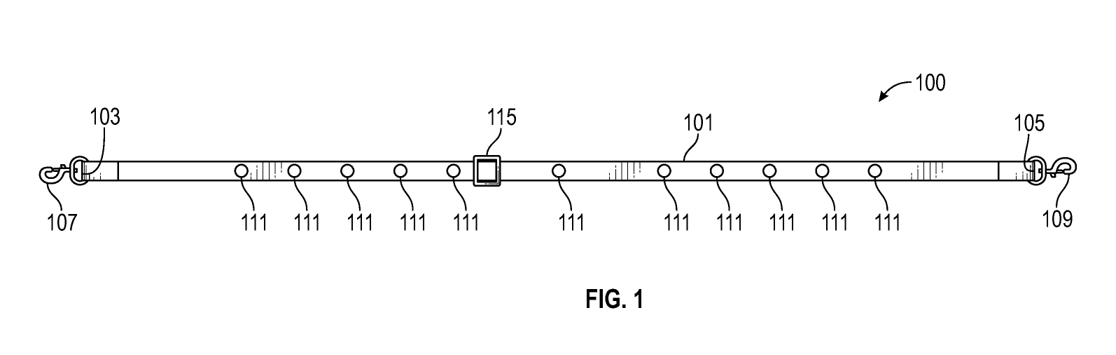

FIG. 1 may depict an embodiment of a leash-with-variable-anchor 100, as viewed from above with leash-with-variable-anchor 100 laid out in longitudinally extended configuration. In some embodiments, leash-with-variable-anchor 100 may comprise: an elongate-member 101, a first-clip 107, and a second-clip 109. In some embodiments, elongate-member 101 may be substantially flexible. In some embodiments, elongate-member 101 may comprise two opposing terminal-ends, a first-terminal-end 103 and a second-terminal-end 105. In some embodiments, first-clip 107 may be attached to first-terminal-end 103. In some embodiments, second-clip 109 may be attached to second-terminal-end 105. In some embodiments, first-clip 107 or second-clip 109 may be removably attachable to a collar or to a harness. In some embodiments, first-clip 107 or second-clip 109 may be spring loaded clips. In some embodiments, first-clip 107 or second-clip 109 may be substantially constructed from one or more metals.

Continuing discussing FIG. 1, in some embodiments, leash-with-variable-anchor 100 may comprise at least one hole 111. In some embodiments, elongate-member 101 may comprise at least one hole 111. In some embodiments, at least one hole 111 may be located in elongate-member 101. In some embodiments, at least one hole 111 may pass entirely through a thickness of elongate-member 101. In some embodiments, at least one hole 111 may be sized to removably receive attachment of first-clip 107 or of second-clip 109. In some embodiments, when first-clip 107 or second-clip 109 may be removably attached to at least one hole 111, an anchor may be formed. In some embodiments, this anchor may be a looped structure. In some embodiments, this anchor may be removably attachable to an article by the anchor wrapping around a portion of the article.

For example, and without limiting the scope of the present invention, this article may be a post, a sign post, a light post, a pole, a telephone pole, a table leg, a bench leg, a table pedestal, a chair leg, a tree trunk, a gate post, a frame member, a structural member, and/or the like. The article may generally be a solid object that a portion of elongate-member 101, i.e., the anchor, may be wrap around.

In some embodiments, the anchor is a handle. That is, the anchor, once formed, may function a handle, so that a user may easily hold leash-with-variable-anchor 100.

Continuing discussing FIG. 1, in some embodiments, at least one hole 111 may be selected from one to twenty holes. For example, and without limiting the scope of the present invention, as shown in FIG. 1, elongate-member 101 may comprise eleven holes 111, with one hole 111 located in a middle of a length of elongate-member 101. Because of such a plurality of holes 111, then a size of the anchor may be variable depending upon which hole 111 that first-clip 107 or that second-clip 109 removably attaches to. In some embodiments, at least one hole 111 may be reinforced with one grommet for each of at least one hole 111. In some embodiments, at least one hole 111 may be located a predetermined distance from first-terminal-end 103 (and/or from second-terminal-end 105). For example, and without limiting the scope of the present invention, a first hole 111 (i.e., closest) from first-terminal-end 103 may be located at about 18 inches from first-terminal-end 103; wherein “about” in this context may mean plus or minus two inches. For example, and without limiting the scope of the present invention, a first hole 111 (i.e., closest) from second-terminal-end 105 may be located at about 18 inches from second-terminal-end 105; wherein “about” in this context may mean plus or minus two inches.

Continuing discussing FIG. 1, in some embodiments, leash-with-variable-anchor 100 may comprise a size-adjuster 115. In some embodiments, size-adjuster 115 may be slidingly attached to elongate-member 101. In some embodiments, size-adjuster 115 may permit a length of elongate-member 101 to be adjusted. In some embodiments, size-adjuster 115 may be a triglide slider. In some embodiments, size-adjuster 115 may be constructed from a thermoplastic.

Continuing discussing FIG. 1, in some embodiments, elongate-member 101 may be longer than wide, and wider than thick. In some embodiments, elongate-member 101 may be webbing or strapping. That is, in some embodiments, elongate-member 101 may be a woven structure, of natural, synthetic, or blended fabric or fibers. Some natural materials of construction for elongate-member 101 may comprise: cotton, silk, hemp, linen, leather, and/or the like. Some synthetic materials of construction for elongate-member 101 may comprise: nylon, polyester, acrylic, polypropylene, and/or the like. In some embodiments, all or portions of elongate-member 101 may be constructed from recycled materials of construction.

Continuing discussing FIG. 1, in some embodiments, first-terminal-end 103 and first-clip 107 may be substantially structurally symmetrical to second-terminal-end 105 and to second-clip 109.

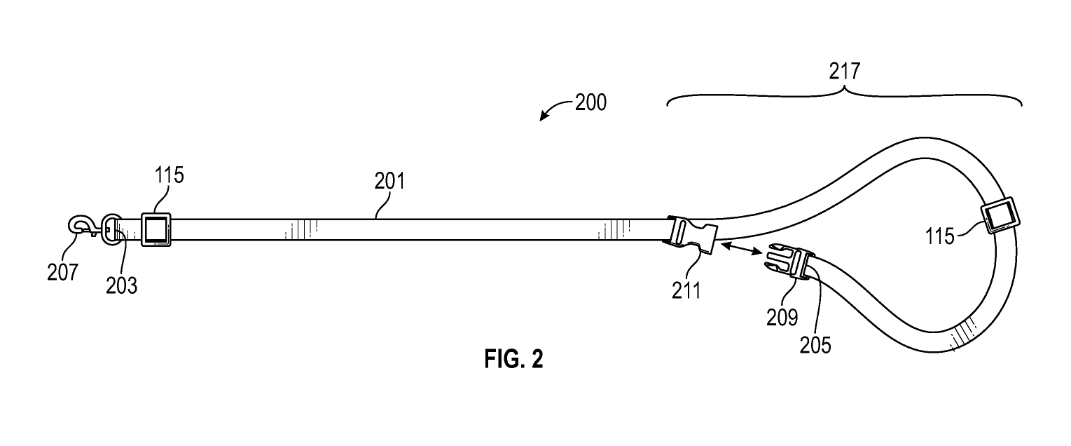

FIG. 2 may depict an embodiment of a leash-with-variable-anchor 200, as viewed from above with leash-with-variable-anchor 200 laid out in a substantially longitudinally extended configuration, but showing a looping structure in a process of forming an anchor 217. In some embodiments, leash-with-variable-anchor 200 may comprise an elongate-member 201, a first-fastener 207, a second-fastener 209, and a second-fastener-receiver 211.

Continuing discussing FIG. 2, in some embodiments, elongate-member 201 may be substantially flexible. In some embodiments, elongate-member 201 may comprise two opposing terminal-ends, a first-terminal-end 203 and a second-terminal-end 205. In some embodiments, elongate-member 201 may be longer than wide, and wider than thick. In some embodiments, elongate-member 201 may be webbing or strapping.

In some embodiments, elongate-member 201 may be substantially similar, in terms of structure and/or in terms of function, to elongate-member 101. For example, both elongate-member 201 and elongate-member 101 may have an overall same structure of an elongate member that is longer than wide, and wider than thick, that may be substantially flexible; that may be webbing or strapping; and that may be constructed from same materials of construction. However, some embodiments of elongate-member 201 may not include at least one hole 111. (Although some embodiments, of elongate-member 201 may comprise at least one hole 111, wherein such embodiments are not depicted in the figures.)

Continuing discussing FIG. 2, in some embodiments, first-fastener 207 may be attached to first-terminal-end 203. In some embodiments, first-fastener 207 may be substantially similar, structurally and/or functionally, to first-clip 107 and/or to second-clip 109. In some embodiments, first-fastener 207 may be removably attachable to a collar or to a harness.

Continuing discussing FIG. 2, in some embodiments, second-fastener 209 may be attached to second-terminal-end 205. In some embodiments, second-fastener-receiver 211 may be attached to elongate-member 201. In some embodiments, second-fastener-receiver 211 may be slidingly attached to elongate-member 201. In some embodiments, second-fastener 209 may be removably attachable to second-fastener-receiver 211. In some embodiments, when second-fastener 209 may be removably attached to second-fastener-receiver 211, an anchor 217 may be formed. In some embodiments, this anchor 217 may be a looped structure, i.e., a looped structure of a portion of elongate-member 201. In some embodiments, this anchor 217 may be removably attachable to the article by anchor 217 wrapping around a portion of the article. Examples of some articles are noted above. In some embodiments, this anchor may be a handle of leash-with-variable-anchor 200.

Continuing discussing FIG. 2, in some embodiments, together second-fastener 209 and second-fastener-receiver 211 may form a quick release buckle. In some embodiments, such a quick release buckle may be substantially constructed from a thermoformed plastic. Note it is expressly contemplated that in some embodiments, a male portion of such a quick release buckle may be second-fastener 209; and that the receiving female portion of such a quick release buckle may be second-fastener-receiver 211. However, it is also expressly contemplated that in some embodiments, a male portion of such a quick release buckle may be second-fastener-receiver 211; and that the receiving female portion of such a quick release buckle may be second-fastener 209.

Continuing discussing FIG. 2, in some embodiments, second-fastener-receiver 211 may be located at about 10 inches to about 24 inches from second-terminal-end 205; wherein “about” in this context may be mean plus or minus two inches. In some embodiments, second-fastener-receiver 211 may be located at about 18 inches from second-terminal-end 205; wherein “about” in this context may be mean plus or minus two inches.

Continuing discussing FIG. 2, in some embodiments, leash-with-variable-anchor 200 may comprise at least one size-adjuster 115. In some embodiments, at least one size-adjuster 115 may be slidingly attached to elongate-member 201. In some embodiments, at least one size-adjuster 115 may permit a length of elongate-member 201 to be adjusted. In some embodi-ments, at least one size-adjuster 115 may comprise two size-adjusters 115, one disposed between first-terminal-end 203 and second-fastener-receiver 211; and a second disposed between second-fastener-receiver 211 and second-terminal-end 205.

Continuing discussing FIG. 2, in some embodiments, anchor 217 may be variable in size by either sliding second-fastener-receiver 211 along a length of elongate-member 202 or by adjusting a length of anchor 217 by using size-adjuster 115 that may be attached to elongate-member 201 disposed between second-terminal-end 205 and second-fastener-receiver 211.

Note with respect to the materials of construction, it is not desired nor intended to thereby unnecessarily limit the present invention by reason of such disclosure.

Leashes-with-variable-anchors have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A leash-with-variable-anchor, comprising:
an elongate-member that is flexible; wherein the elongate-member comprises two opposing terminal-ends, a first-terminal-end and a second-terminal-end;
a first-clip attached to the first-terminal-end;
a second-clip attached to the second-terminal-end;
wherein the first-clip or the second-clip is removably attachable to a collar or to a harness.

2. The leash-with-variable-anchor according to claim 1, wherein the leash-with-variable-anchor comprises at least one hole in elongate-member; wherein the at least one hole passes entirely through a thickness of the elongate-member and the at least one hole is sized to removably receive attachment of the first-clip or of the second-clip; wherein when the first-clip or the second-clip is removably attached to the at least one hole, an anchor is formed; wherein the anchor is a looped structure; wherein the anchor is removably attachable to an article by the anchor wrapping around a portion of the article.

3. The leash-with-variable-anchor according to claim 2, wherein the anchor is a handle.

4. The leash-with-variable-anchor according to claim 2, wherein the at least one hole is selected from one to twenty holes.

5. The leash-with-variable-anchor according to claim 2, wherein the at least one hole is reinforced with one grommet for each of the at least one hole.

6. The leash-with-variable-anchor according to claim 2, wherein the at least one hole is located a predetermined distance from the first-terminal-end.

7. The leash-with-variable-anchor according to claim 1, wherein the leash-with-variable-anchor further comprises a size-adjuster that is slidingly attached to the elongate-member; wherein the size-adjuster permits a length of the elongate-member to be adjusted.

8. The leash-with-variable-anchor according to claim 1, wherein the elongate-member is webbing or strapping.

9. The leash-with-variable-anchor according to claim 1, wherein the elongate-member is longer than wide, and wider than thick.

10. The leash-with-variable-anchor according to claim 1, wherein the first-terminal-end and the first-clip are substantially structurally symmetrical to the second-terminal-end and to the second-clip.

11. A leash-with-variable-anchor, comprising:
an elongate-member that is flexible; wherein the elongate-member comprises two opposing terminal-ends, a first-terminal-end and a second-terminal-end;
a first-fastener attached to the first-terminal-end;
a second-fastener attached to the second-terminal-end;
a second-fastener-receiver slidingly attached to the elongate-member;
wherein the first-fastener is removably attachable to a collar or to a harness; and
wherein the second-fastener is removably attachable to the second-fastener-receiver; wherein when the second-fastener is removably attached to the second-fastener-receiver, an anchor is formed; wherein the anchor is a looped structure; wherein the anchor is removably attachable to an article by the anchor wrapping around a portion of the article.

12. The leash-with-variable-anchor according to claim 11, wherein the anchor is a handle.

13. The leash-with-variable-anchor according to claim 11, wherein the leash-with-variable-anchor further comprises at least one size-adjuster that is slidingly attached to the elongate-member; wherein the at least one size-adjuster permits a length of the elongate-member to be adjusted.

14. The leash-with-variable-anchor according to claim 13, wherein at least one size-adjuster comprises two size-adjusters, one disposed between first-terminal-end and the second-fastener-receiver; and a second disposed between the second-fastener-receiver and the second-terminal-end.

15. The leash-with-variable-anchor according to claim 1, wherein the elongate-member is webbing or strapping.

16. The leash-with-variable-anchor according to claim 1, wherein the elongate-member is longer than wide, and wider than thick.

17. The leash-with-variable-anchor according to claim 1, wherein together the second-fastener and the second-fastener-receiver form a quick release buckle.

18. The leash-with-variable-anchor according to claim 1, wherein the anchor is variable in size by either sliding the second-fastener-receiver along a length of the elongate-member or by adjusting a length of the anchor by using a size-adjuster that is attached to the elongate-member disposed between the second-terminal-end and the second-fastener-receiver.
